(19) United States
(12) Patent Application Publication
(10) Pub. No.: US 2003/0031532 A1
(43) Pub. Date: Feb. 13, 2003

(54) System and a method for providing stapled and folded booklets with a souare back

(76) Inventors: Karl Nolte, Huddinge (SE); Richard Arnstein, Strangnas (SE)

Correspondence Address: J. Warren Whitesel, Michael Best & Friedrich LLC, Suite 1900, 401 N. Michigan Avenue, Chicago, IL, 60611, US

(21) Appl. No.: 10/196,891

(22) Filed: Jul. 16, 2002

(30) Foreign Application Priority Data
Jul. 19, 2001 (SE) 0102566-7

(51) Int. Cl. B42B 5/00

(52) U.S. Cl. 412/33

(57) ABSTRACT

The invention concerns a system and a method for preferably on-line providing stapled and folded booklets with a square back. The system comprises means (1a, 1b) for feeding a booklet (H) forwardly and in reverse Furthermore, there is a stopper (2a) for stopping a fed-in booklet, two elongated bars (4, 5) adapted to clamp the booklet (H) between them, and displaceable means (9) for engaging a booklet clamped between the elongated bars (4, 5) for lending the back of the booklet square shape. In the method, a booklet (H) is fed in between two elongated bars (4, 5) to a stopper (2a), whereafter the elongated bars (4, 5) clamp the booklet (H), a movable member (9) is urged against the back of the booklet (H) so as to make it square-shaped, the elongated bars (4, 5) are moved apart, and the completed booklet is fed out in reverse.

This invention concerns a system and a method for providing stapled and folded booklets with a square back, particularly in on-line feeding.

Booklets which are produced in stapling and folding machines (booklet makers) conventionally have an appearance which is not commensurate with booklets or books produced by other processes, for example adhesive binding. Above all, when the number of sheets in a booklet exceeds four or five, the booklet begins to bulge, and when the number of sheets is close to twenty or twenty-two it may sometimes be difficult to close the booklet so as to make it lie flat. In conventional technology booklets are often placed on top of each other with their backs in opposite directions from booklet to booklet under pressure which is applied for instance for twenty-four hours to make the booklets lie flat.

As examples of the relevant stapled and folded booklets mention may be made of annual reports for companies, travel brochures, advertising brochures, manuals, etcetera. When a number of these booklets are placed on top of each other with their backs facing in the same direction the above-mentioned bulging is clearly discernible.

In the prior art, U.S. Pat. Specification No. 5,221,112 shows a method and apparatus for binding a plurality of folded sheets together by assembling the folded sheets with their fold lines in registration, clamping the assembled sheets together at their registered fold lines, applying adhesive to the fold lines and controlling the penetration of the adhesive into the areas between the clamped together registered folded edges. Hence, the mentioned United States patent does not have the object of providing folded sheets inserted into each other with a square back,

European Patent Application No. 1 138 521 A2 refers to methods and apparatus for producing booklets which are fixedly held by endwise clamping jaws with a forming roller being passed one or more times along the length of a protruding spine with sufficient pressure to produce a flattening of the curvature of the spine. This is similar to the solution of the present invention, in which however the clamping means consist of two elongated bars opposing each other and the displaceable means for engaging the back of the booklet consists of a compression roller which rotates around a shaft in a carriage which is displaceable in the longitudinal direction of the two bars.

The system and the method of the invention are unique in that they have the characteristic of being able to be utilized on-line together with other products, for example booklet makers, trimmers, etcetera, and in that the system in consequence of its small dimensions easily can be mounted in other units for the final processing of documents, The system and method can of course also be used off-line.

In order for the system and method to be used as an on-line solution the design is required to be fully automatic with regard to settings for the thickness of the booklets and the dimensions of the booklets, with the design being independent of the quality of the paper which is utilized.

The means by which the object which is set forth above is achieved are defined in the accompanying claims.

The invention will be described more specifically in the following with reference to the accompanying drawings, in which

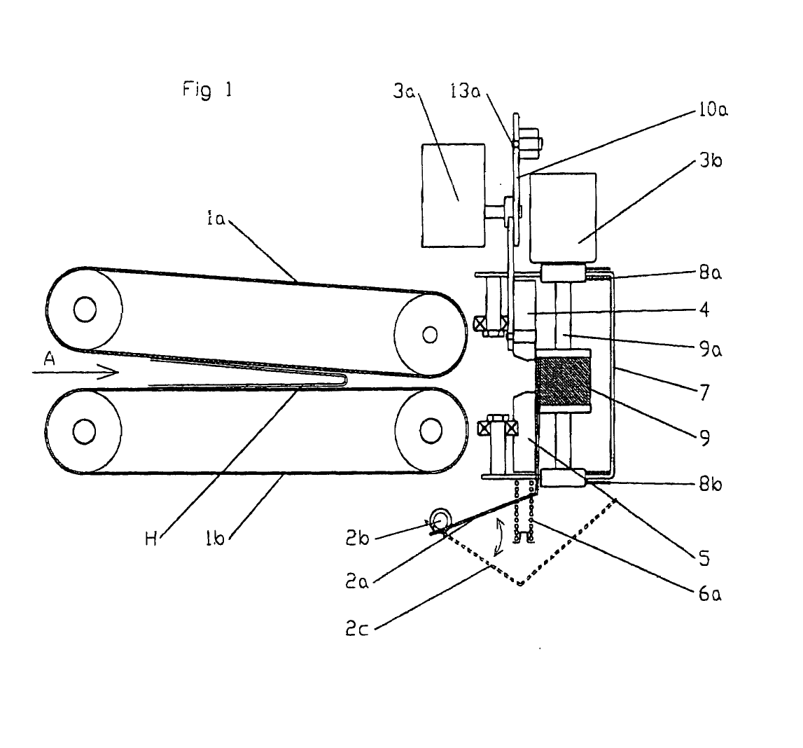

FIG. 1 is a lateral view illustrating the principle of feeding stapled and folded sets of paper, in the following called booklets, in the system of the invention,

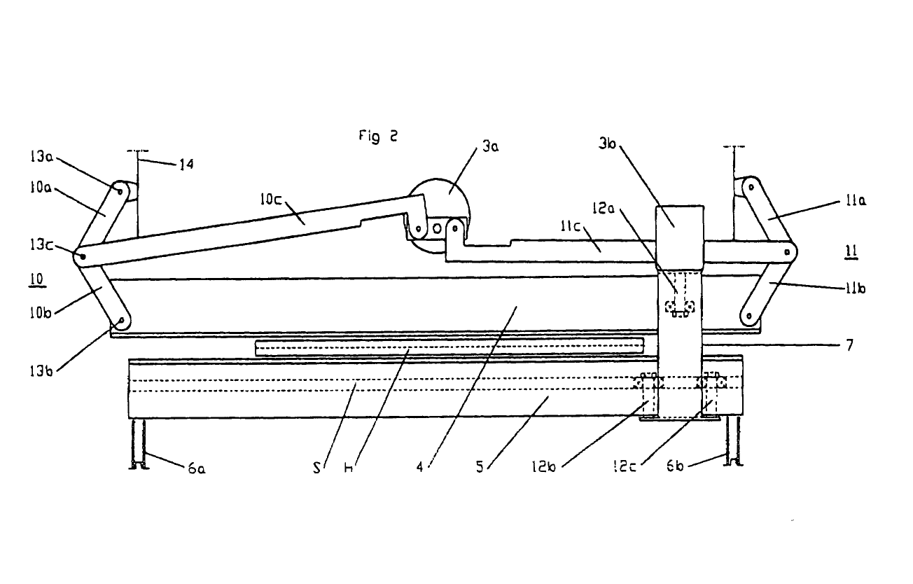

FIG. 2 is a view taken at right angles to FIG. 1 and illustrating i.a. two bars in a position in which a booklet has been introduced between them,

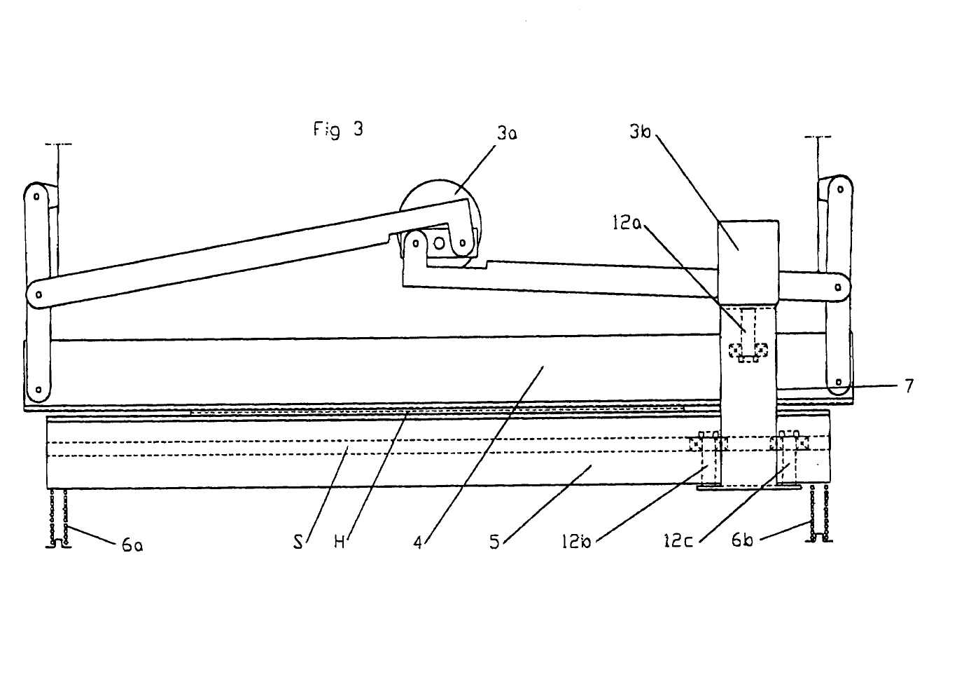

FIG. 3 shows the system of FIG. 2 with the bars nearly closed,

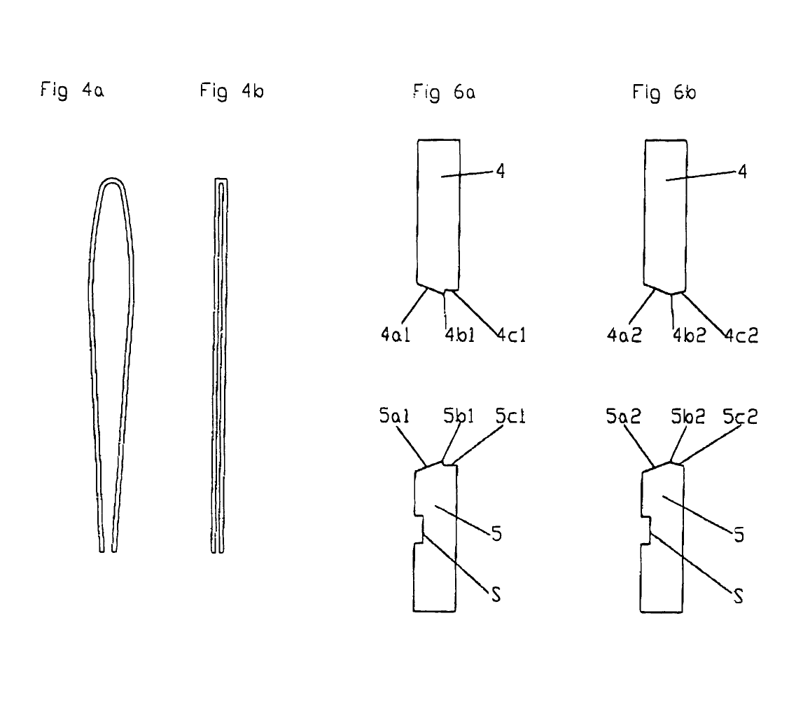

FIG. 4a shows a lateral view of the booklet before processing in the system of the invention, FIG. 4b shows a lateral view of the booklet after processing,

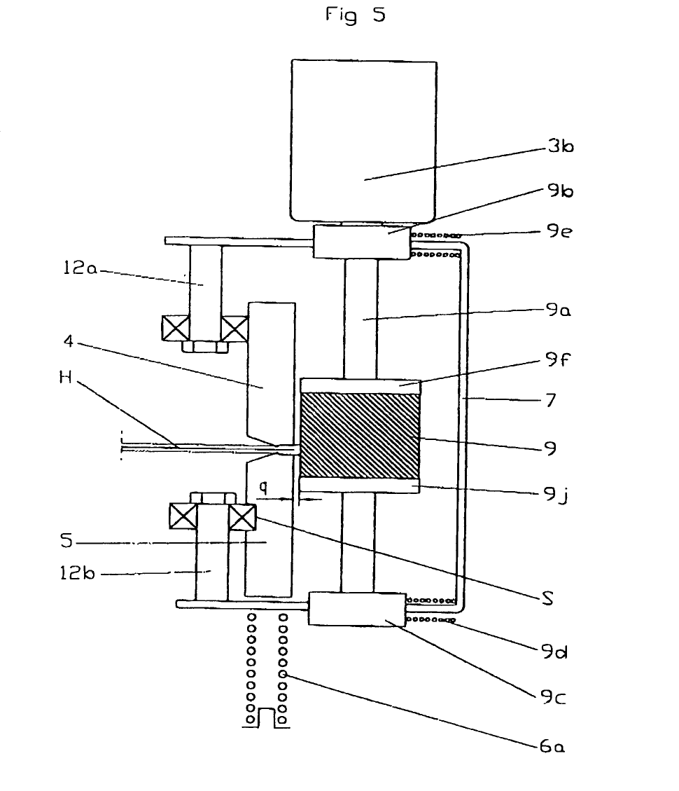

FIG. 5 shows a lateral view of a carriage with a compression roller in accordance with the invention for producing a square back on a booklet, and

FIGS. 6a and 6b, respectively, illustrate the positioning of interacting edges on the respective bars 4 and 5 on an enlarged scale.

In FIG. 1 the designations 1a and 1b refer to two powered friction belts which converge towards their right-hand ends. H is a booklet which has been introduced between the powered friction belts and which is fed forward in the direction of arrow A. 2a designates a stopper for introduced booklets, which stopper may be rotated around a shaft 2b to a stopping position for the booklets. The designation 2c illustrates said stopper urged downwards so that the booklets can pass through, and 3a is a motor for driving two knee-joints which may be seen more clearly in FIGS. 2 and 3, respectively, and which will be explained more specifically below.

Furthermore, in FIG. 1 the designations 4 and 5 refer to two mutually parallel longitudinal bars viewed from one end, said bars being shown from one side in FIGS. 2 and 3 and which can be urged against each other with the intermediately positioned folded booklet H in manner which will be explained below. The designations 6a and 6b refer to two springs which are positioned essentially each at a respective end of the lower bar 5 and which are urged against the bar 5 from underneath, 7 is a carriage viewed from the side and basically taking the form of a short U-beam which is open at both of its ends and which supports a rotatable compression roller 9 which is driven via a shaft 9a of a cooperating motor 3b for being urged against the back of an introduced booklet when the latter has been fed forward between the friction belts 1a and 1b to its final position (not shown) between the bars 4 and 5, and 9e and 9d are springs which at the upper and lower end of the carriage urge shaft 9a of the compression roller 9 towards the bars 4 and 5.

Some of the components that are illustrated in FIG. 1 may be seen in FIG. 2 which also shows that when motor 3a rotates this affects the respective knee-joints 10 and 11 so that they can be straightened out and can urge the upper bar 4 towards the lower bar 5. The manner in which this is done will be explained more specifically below. FIG. 2 also shows the carriage 7, which in displaceable longitudinally of the bars 4, 5, in one of its end positions.

The structure illustrated in FIGS. 2 and 3 with motor 3a and knee-joints 10, 11 is very simple, namely as follows: the left knee-joint in FIG. 2 comprises two arms 10a and 10b, each of which is articulated around a pin 13a and 13b, respectively, said arms rotatably engaging each other at one of their respective ends 13c. Pin 13a is attached to an end plate 14 and pin 13b is attached to bar 4. The right-hand knee-joint is designed in corresponding manner. In consequence of motor 3a rotating clockwise from its initial position which is shown in FIG. 2 arms 10a and 10b as well as 11a and 11b, respectively, will be set linearly with regard to each other after somewhat more than half a revolution of the motor and concurrently bar 4 will have moved to its lower end position nearly in engagement with bar 5 with the booklet H clamped between the bars as illustrated in FIG. 3. As has been mentioned above the lower bar 5 is urged from underneath at its ends by means of springs 6a and 6b. On the other hand bar 4 is securely fixed in its lower position when arms 10a and 10b as well as 11a and 11b, respectively, are positioned linearly with regard to each other.

FIG. 4a shows a folded booklet prior to being processed in the system of the invention, wherein it can be seen that the booklet bulges, i.e. widens, and FIG. 4b shows the booklet after processing according to the invention, wherein the booklet has been provided with a square back and is completely flat, i.e. closed.

FIG. 5 shows the displaceable carriage 7 illustrated from the side on an increased scale as compared to FIG. 1. As has been mentioned above the carriage basically takes the form of a short U-beam which is open at its ends. Shaft 9a is mounted in bearings 9b and 9c at its ends, with the two springs 9d and 9e being urged against said bearings, and shaft 9a supports the above-mentioned rotatable compression roller 9 at its middle, said roller having a rough hard surface and running close to the two bars 4 and 5 so that it can be urged against the back of a booklet which has been introduced between the bars. Compression roller 9 is retained a short distance q from bars 4 and 5 by means of circular end pieces 9f and 9j on the roller. The springs 9d and 9e determine the pressure between the compression roller 9 and the back of the booklet H. The above-mentioned spring 6a and its cooperating spring 6b (FIGS. 2 and 3) apply pressure to the lower bar 5 from below and secure a minimum pressure between the bars and an increased pressure on a thicker booklet.

Carriage 7 can preferably be driven at high speed from one end of the bars 4 and 5 to the other by means of a motor 3b which drives shaft 9a. Three guide bearings 12a, 12b and 12c (FIGS. 2, 3 and 5, respectively) in the carriage engage the longitudinal sides of the bars 4 and 5, respectively, facing away from the carriage. Guide bearing 12a is a backup bearing against bar 4 and guide bearings 12b and 12c run in a guide track 5 in bar 5 in manner shown in FIG. 5. By interaction between on the one hand the guide bearings 12a, 12b and 12c, respectively, which are mounted in carriage 7, and on the other hand springs 9e and 9d and the end bearings 9b and 9c of shaft 9a it is in simple manner achieved that carriage 7 is centered around the bars and that the compression roller 9 in its rolling, when carriage 7 is moved in the longitudinal direction of the bars, is strongly urged against the back of a booklet H which has been introduced betweens bars 4 and 5, respectively, resulting in the booklet being provided with a pronounced square back.

The end portions of the bars 4 and 5 are illustrated more specifically in FIGS. 5, 6a and 6b, respectively, and it may be seen in FIG. 6a that the longitudinal sides have bevelled surfaces facing each other with profiles 4a1 and 5a1, respectively, which terminate with edges 4b1 and 5b1, respectively, said edges being followed by an essentially horizontal release portion with profiles 4c1 and 5c1, respectively. Edges 4b1 and 5b1, respectively, interact to securely retain a booklet introduced therebetween when the bars 4 and 5 engage each other with bar 4 affixed in its lowermost position by means of arms 10a and 10b and 11a and 11b, respectively, and bar 5 engaged from below by springs 6a and 6b. Alternatively, the structure of the opposing surfaces of the bars can be as illustrated in FIG. 6b, with 4a2 and 5a2 being bevelled surfaces, 4b2 and 5b2 being longitudinal edges on bars 4 and 5, respectively, and 4c2 and 5c2, respectively, being bevels in the opposite direction of bevels 5a1 and 5a2. The proportions between profile 4a1 and the release portion 4c1 of bar 4 and the corresponding bar 5 may to advantage be approximately 2:1. The mentioned edges cause fold lines to be formed a predetermined distance from the edge of a booklet which is introduced between bars 4 and 5, which lines will be discussed more specifically below. The elongated surfaces provided with interacting edges and facing each other are of significance for the function of the invention because completely flat surfaces interacting with each other on the bars 4 and 5 would not be able to hold a booklet introduced therebetween securely as its back is subjected to the pressure of the compression roller, and the booklet would in such case slide backwards so that the required square back would not be achievable. In order for good results to be achieved the above-mentioned release portion has to be disposed behind the edge.

The system of the invention operates in following manner: The booklet which is to be provided with a square back can for example consist of a number of sheets with text or print, for example of size Continental A4, which are positioned on each other and are stapled for instance by means of two staples and in known manner are folded to booklets of size A5. The stapled and folded booklets are fed in the direction of the arrow A in FIG. 1 between the two powered friction belts 1a and 1b to a position in which the front portion of the booklet engages the stopper which at that moment is in its upward position which is designated 2a The position in which the booklet is to stop may be determined for example by means of a sensor which shortly before the booklet is to stop releases a time countdown or by for example two sensors setting predetermined limits for the back of the booklet.

For use with a thin booklet the stopper can be completely closed until the feed-in end of the booklet is secured by the bars, whereafter the stopper is turned downwards so that the compression roller can run along the rounded back of the booklet so as to shape said back to a square back. With a thicker booklet the stop is turned down as soon as it has carried out its initial action, i.e. stopped the booklet, so that the above-mentioned surfaces of the bars provided with edges and facing each other can begin to close, whereafter the bars are tightly clamped together and the back end of the booklet can bulge in response to the thickness of the booklet. In both of these instances the interacting edges create the above-mentioned fold lines on the booklet when they clamp it in position and the compression roller is urged against the back of the booklet during its rotational movement so as to create the square back. The fold lines are advantageous in that they comprise fractural lines which come to good use when the booklet is to be opened and closed, respectively, by the user.

When the booklet strikes the stopper, the back of the booklet is straightened in consequence of the friction belts, and the back of the booklet becomes fully parallel to stopper 2a and to the two bars 4 and 5 respectively. When the booklet has been straightened, the friction belts 1a and 1b cease running, for example on the basis of the above-mentioned time countdown, and stopper 2a is concurrently rotated around shaft 2b to position 2c. At that time the booklet is loosely positioned between the respective bars 4 and 5. Thereafter motor 3a is started, for example by means of a sensor (not shown), said motor in manner described above operating knee-joints 10 and 11 and urging the upper bar 4 against the lower bar 5 with the booklet lying between them with its back portion extending to the right of the two bars in such position that compression roller 9 (FIG. 5) in its preferably rapid longitudinal movement along the back of the booklet when carriage 7 is powered by motor 3 will provide the booklet with a square back in manner which will more specifically described below.

As the lower bar 5 is spring-urged from underneath by springs 6a and 6b a sufficient engagement force will always be available to hold the booklet immovable between the bars 4 and 5 during the process, irrespective of the thickness of the booklet, on the condition that the bars have the above-mentioned edges facing each other and interacting with each other when a booklet is introduced between the bars and the latter are urged towards each other. The intended result will not be achieved if these edges are lacking, as the booklet then will slide. The greater the thickness of the booklet, the greater the clamping pressure.

As is mentioned above, carriage 7 illustrated in FIG. 5 preferably runs at high speed along the back of the booklet along the entire length of the booklet, with the compression roller, which has a hard surface and is very durable, at that time being urged with great force against the back of the booklet so that the latter is converted from its shape shown in FIG. 4a to its square shape shown in FIG. 4b when the folded sheets of the booklet exceed the ductile limit and change from the bulging shape illustrated in FIG. 4a to the straight shape illustrated in FIG. 4b. As is mentioned above springs 9d and 9e keep the carriage shaft 9 urged in the direction of the back of the booklet with the pressure of the compression roller adapting itself to the thickness of the booklet. The compression roller 9 is preferably driven rapidly along the entire distance of the back of the booklet one or more times by means of motor 3b and is controlled by for example end stoppers or sensors at the end positions of the compression roller. When motor 3b has stopped, motor 3a is actuated so as to move the upper bar 4 upwards, whereby the booklet is released and rapidly is transferred out of the system by means of the friction belts 1a and 1b which have been started again to run in reverse, for example by a sensor after the compression roller has carried out its work. Thereupon stopper 2a rises from its lower position and serves as a stopper for the next forwardly fed booklet.

FIG. 4a shows a folded booklet before it is processed in the system of the invention, wherein it is seen that the booklet bulges, i.e. widens, and FIG. 4b shows the booklet after processing in accordance with the invention, with the booklet having been provided with a square back and being flat, i.e. closed.

All driven units in the system can be powered by motors and/or sensors in manner known per se.

The invention is not restricted to the embodiment described above and illustrated in the drawings, as this is only an example of the invention and its mode of application.

1. A system for providing stapled and folded booklets with a square back preferably on-line, said system comprising means (1a, 1b) for feeding a booklet (H) forward and in reverse, stopper means (2a) for stopping a forwardly-fed booklet, two elongated bars (4, 5) adapted to clamp the folded end of the booklet (H) therebetween, and a rotatable compression roller (9) for engaging a booklet clamped between said bars (4, 5) for lending the back of the booklet square shape, wherein said compression roller (9) is adapted to rotate around a shaft (9a) in a carriage (7) that is displaceable in the longitudinal direction of said bars (4, 5).

2. A system in accordance with claim 1, wherein it comprises at least two guides (12a, 12b) supported by said carriage and adapted to be pushed against said bars (4, 5) in interaction with pressure means (9d, 9e) on said carriage (7).

3. A system in accordance with claim 1, wherein the compression roller (9) has a rough, hard surface.

4. A system in accordance with claim 2, wherein said pressure means (9e, 9b) are constituted by springs.

5. A system in accordance with any one of claims 2-4, wherein pairs of knee-joints (10, 11) and springs (6a, 6b) are adapted to urge said bars (4, 5) into engagement with each other with the booklet therebetween.

6. A system in accordance with any one of claims 1-5, wherein the longitudinal surfaces of said bars (4, 5) facing each other are provided with interacting edges (4b, 6b) for engaging an introduced booklet, and each one of the respective edges (4b, 5b) interacts with a release portion (4c1, 5c1).

7. A method of producing a square back on stapled and folded booklets, wherein said booklets are fed forward one at a time to a stopper (2), two elongated bars (4, 5) are driven towards each other at right angles to said booklet so that the latter is clamped in a position between said bars (4, 5), said stopper (2) is removed, and a compression roller (9) is made to engage the back of said stapled and folded booklet repeatedly so that said back takes the shape of a square back, and said compression roller (9) is supported by a carriage (7) which is urged by springs (9d, 9e) in the direction of said bars (4, 5).

8. A method in accordance with claim 7, wherein said carriage (7) supports at least two guides (12a, 12b) which are urged against the longitudinal sides of said bars (4, 5) facing away from said carriage and interacting with said urging of said springs.
